(19) United States
(12) Patent Application Publication
(10) Pub. No.: US 2020/0234496 A1
(43) Pub. Date: Jul. 23, 2020

(54) NAVIGATING IN A VIRTUAL ENVIRONMENT

(71) Applicant: Technologies Aperium Inc., Montreal (CA)

(72) Inventors: Jonathan de Belle, Montreal (CA); Simon Dufour, Montreal (CA); Antoine Rivard, Varennes (CA)

(73) Assignee: Aperium Technologie Inc, Montreal, QC (CA)

(21) Appl. No.: 16/643,801

(22) PCT Filed: Sep. 5, 2018
(86) PCT No.: PCT/CA2018/051075

§ 371 Date: Mar. 2, 2020

Related U.S. Application Data
(60) Provisional application No. 62/554,423, filed on Sep. 5, 2017.

(51) Int. Cl. G06T 19/00; A63B 22/02; A63B 24/00; G06F 3/01

(52) U.S. Cl. CPC G06T 19/003; A63B 22/025; G06F 2203/012; G06F 3/011; A63B 2024/009; A63B 24/0087

(57) ABSTRACT

Systems, methods, and storage media for navigating in a virtual environment considering imprecision from a user's inner ear vestibular systems. Exemplary implementations may define a point of view for a user in the virtual environment; when the user walks in a real environment, define a vector r1 therein and compute a first vector vr1 in the virtual environment from r1 with vr1 having an x component, ay component and a rotational component θ; in real-time priority processing and while user walks, compute a second vector vr2 in the virtual environment having an x-translation component Δx, a y-translation Δy component and a rotational component Δθ with at least one of Δx, Δy and Δθ being effective for inducing a translation and/or rotation of the point of view in the virtual environment while the user walks; and move the point of view along vr1 taking into account vr2.

### PRIORITY STATEMENT

This non-provisional patent application claims priority based upon the prior U.S. provisional patent application entitled “VIRTUAL REALITY SYSTEM AND METHOD”, application No. 62/554,423, filed on Sep. 5, 2017, in the name of Technologies Aperium Inc.

### TECHNICAL FIELD

The present disclosure relates to systems, methods, and storage media for navigating in a virtual environment considering imprecision from user's inner ear vestibular systems.

### BACKGROUND

Nowadays, various virtual reality devices and systems have been proposed to allow creating a virtual reality experience for a user. Thus, various systems allow users to be completely immersed in a virtual environment by mapping their movements within the virtual environment using a conversion scale of 1:1 between the real and virtual environment. However, a problem of these systems and devices is creating a virtual environment being larger than the real environment to which the user's movement is limited.

Recently, some locomotion systems, such as, but not limited to, joysticks and point and click mechanics have been proposed to move a user within a virtual space. Although these systems allow creating the user's presence in a virtual environment, these systems either induce some undesirable physiological side effects, such as nausea, or significantly break with the virtual immersion experience for the user.

Accordingly, there is a need for a more convenient system of moving within a virtual environment.

### SUMMARY

The summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

One aspect of the present disclosure relates to a computing platform configured for navigating in a virtual environment considering imprecision from user's inner ear vestibular systems. The computing platform may include a non-transient computer-readable storage medium having executable instructions embodied thereon. The computing platform may include one or more hardware processors configured to execute the instructions. The processor module executes the instructions to define a three-dimensional (3D) computer generated virtual environment. The processor module also executes the instructions to define a point of view for a user in the 3D virtual environment. The user has a defined position in a real environment defined using a longitudinal x axis, a lateral y axis and a perpendicular z axis. The processor module executes the instructions to, when the user walks in the real environment, define a vector of movement r1 in the real environment and computing a first vector of movement vr1 in the 3D virtual environment from r1 with vr1 having a component x along the x axis, a component y along the y axis and a rotational component θ around the z axis. The processor module also executes the instructions to, in real-time priority processing and while the user walks in the real environment, compute a second vector of movement vr2 in the 3D virtual environment having an x-translation component Δx along the x axis, a y-translation Δy component along the y axis and a rotational component Δθ around the z axis with at least one of Δx, Δy and Δθ being effective for inducing a translation and/or rotation of the point of view in the 3D virtual environment while the user walks, the induced translation and/or rotation being absent from vr1. The processor module executes the instructions to move the point of view in the 3D virtual environment along vr1 taking into account vr2.

In some implementations of the computing platform, the processor module may execute the instructions to define a target multidimensional path in the 3D virtual environment, computing vr2 being performed to match the target multidimensional path while the user walks unidimensionally in the real environment.

In some implementations of the computing platform, the processor module may execute the instructions to segment the moving of the point of view in the 3D virtual environment into multiple frames per second wherein the vectors r1, vr1 and vr2 are computed for each of the multiple frames.

In some implementations of the computing platform, Δx may be a gain applied to a corresponding x component of vr1 the gain with Δx being different from 0. Δy is a dynamic gain applied to the corresponding y component of vr1. The gain Δy is greater than 1 when inducing the translation of the point of view in the 3D virtual environment while the user walks. Δθ is greater or equal to 0 and added to the θ component of vr1 Δθ being greater than 0 when inducing the rotation of the point of view in the 3D virtual environment while the user walks.

In some implementations of the computing platform, the gain Δx may be fixed to a value greater than 1 and smaller than 10. In order to maintain an impression of realism during the experience, the gain may be set, for instance, to a value up to 1.5. However, in the context of gaming or action-based experiences, it has been shown that gains up to 5 are achievable while keeping most users comfortable. The gain may be as high as 10 in some instances.

In some implementations of the computing platform, the gain Δy may be dynamically set to a value greater than 1 and smaller than 10 considering at least one of a distance value calculated from the x-component and/or the y-component of r1 and a total rotation value calculated from the θ component of r1 and a maximum value of Δθ is set considering a distance value calculated from an x-component and/or a y-component of r1 and a total rotation value calculated from the θ component of r1. In order to maintain an impression of realism during the experience, the gain may be set, for instance, to a value up to 1.5. However, in the context of gaming or action-based experiences, it has been shown that gains up to 5 are achievable while keeping most users comfortable. The gain may be as high as 10 in some instances.

In some implementations of the computing platform, the processor module may execute the instructions to, in order to evaluate discomfort of the user in the 3D virtual environment, define: a first coefficient defined as Δθ compared to the distance value, a second coefficient is defined as Δy compared to the distance value. In some implementations of the computing platform, a third coefficient may be defined as Δθ compared to the total rotation value and a fourth coefficient is defined as Δy compared to the total rotation value. In some implementations of the computing platform, computing vr2 may be a computer engineering optimization problem of the first, second, third and fourth coefficients to match the target multidimensional path while the user walks unidimensionally in the real environment.

In some implementations of the computing platform, the user may walk in the real environment on a single-dimension treadmill. In some implementations of the computing platform, the method may further include controlling a motor assembly of the treadmill for moving the user thereon from r1, vr1 and vr2.

In some implementations of the computing platform, the processor module may execute the instructions to trigger the motor assembly to drive the treadmill when a distance between a front limit of the treadmill is within a predetermined dynamic or static threshold.

In some implementations of the computing platform, the processor module may execute the instructions to trigger the motor assembly to stop the treadmill when a distance between a rear limit of the treadmill is within a predetermined dynamic or static threshold.

In some implementations of the computing platform, the processor module may execute the instructions to, when the user walks without triggering the motor assembly to drive the treadmill, Δy has a fixed gain value greater than 1 and Δx has a fixed gain value greater than 1. In some implementations of the computing platform, the processor module may execute the instructions to, when the user walks and triggers the motor assembly to drive the treadmill, Δy has a dynamic gain value greater than 1 and Δx has a dynamic gain value greater than 1.

In some implementations of the computing platform, a speed of the treadmill may be determined to keep the user at a center position of the treadmill.

Another aspect of the present disclosure relates to a method for navigating in a virtual environment considering imprecision from user's inner ear vestibular systems. The method includes defining a three-dimensional, 3D, computer generated virtual environment. The method includes defining a point of view for a user in the 3D virtual environment. The user may have a defined position in a real environment defined using a longitudinal x axis, a lateral y axis and a perpendicular z axis. The method includes, when the user walks in the real environment, defining a vector of movement r1 in the real environment and computing a first vector of movement vr1 in the 3D virtual environment from r1 with vr1 having a component x along the x axis, a component y along the y axis and a rotational component θ around the z axis.

The method then includes, in real-time priority processing and while the user walks in the real environment, computing a second vector of movement vr2 in the 3D virtual environment having an x-translation component Δx along the x axis, a y-translation Δy component along the y axis and a rotational component Δθ around the z axis with at least one of Δx, Δy and Δθ being effective for inducing a translation and/or rotation of the point of view in the 3D virtual environment while the user walks, the induced translation and/or rotation being absent from vr1. The method may include moving the point of view in the 3D virtual environment along vr1 taking into account vr2.

In some implementations of the method, it may comprise defining a target multidimensional path in the 3D virtual environment, computing vr2 being performed to match the target multidimensional path while the user walks unidimensionally in the real environment.

In some implementations of the method, it may comprise segmenting the moving of the point of view in the 3D virtual environment into multiple frames per second wherein the vectors r1 vr1 and vr2 are computed for each of the multiple frames.

In some implementations of the method, Δx may be a gain applied to a corresponding x component of vr1 the gain Δx being different from 0, Δy is a dynamic gain applied to the corresponding x component of vr1 the gain with Δy being greater than 1 when inducing the translation of the point of view in the 3D virtual environment while the user walks; and Δθ is greater or equal to 0 and added to the θ component of vr1 with Δθ being greater than 0 when inducing the rotation of the point of view in the 3D virtual environment while the user walks.

In some implementations of the method, the gain Δx may be fixed to a value greater than 1 and smaller than 10.

In some implementations of the method, Δy may be dynamically set to a value greater than 1 and smaller than 10 considering at least one of a distance value calculated from at least one of the x-component and the y-component of r1 and a total rotation value calculated from the θ component of r1 and a maximum value of Δθ is set considering the distance value calculated from at least one of the x-component and the y-component of r1 and the total rotation value calculated from the θ component of r1.

In some implementations of the method, it may comprise, to evaluate discomfort of the user in the 3D virtual environment, defining a first coefficient is defined as Δθ compared to the distance value, a second coefficient is defined as Δy compared to the distance value. In some implementations of the method, third coefficient may be defined as Δθ compared to the total rotation value and a first coefficient is defined as Δy compared to the total rotation value. In some implementations of the method, computing vr2 may be a computer engineering optimization problem of the first, second, third and fourth coefficients to match the target multidimensional path while the user walks unidimensionally in the real environment.

In some implementations of the method, the user may walk in the real environment on a single-dimension treadmill. In some implementations of the method, the method may further comprise controlling a motor assembly of the treadmill for moving the user thereon from r1, vr1 and vr2.

In some implementations of the method, it may comprise triggering the motor assembly to drive the treadmill when a distance between a front limit of the treadmill is within a predetermined dynamic or static threshold.

In some implementations of the method, it may comprise triggering the motor assembly to stop the treadmill when a distance between a rear limit of the treadmill is within a predetermined dynamic or static threshold.

In some implementations of the method, it may comprise, when the user walks without triggering the motor assembly to drive the treadmill, Δy has a fixed gain value greater than 1 and Δx has a fixed gain value greater than 1. In some implementations of the method, it may include, when the user walks and triggers the motor assembly to drive the treadmill, Δy has a dynamic gain value greater than 1 and Δx has a dynamic gain value greater than 1.

In some implementations of the method, a speed of the treadmill may be determined to keep the user at a center position of the treadmill.

Yet another aspect of the present disclosure relates to a system configured for navigating in a virtual environment considering imprecision from user's inner ear vestibular systems. The system may include one or more hardware processors configured by machine-readable instructions. The processor module may be configured to define a three-dimensional, 3D, computer generated virtual environment. The processor module may be configured to define a point of view for a user in the 3D virtual environment. The user may have a defined position in a real environment defined using a longitudinal x axis, a lateral y axis and a perpendicular z axis.

The processor module may be configured to, when the user walks in the real environment, define a vector of movement r1 in the real environment and computing a first vector of movement vr1 in the 3D virtual environment from r1 with vr1 having a component x along the x axis, a component y along the y axis and a rotational component θ around the z axis. The processor module may be configured to, in real-time priority processing and while the user walks in the real environment, compute a second vector of movement vr2 in the 3D virtual environment having an x-translation component Δx along the x axis, a y-translation Δy component along the y axis and a rotational component Δθ around the z axis with at least one of Δx, Δy and Δθ being effective for inducing a translation and/or rotation of the point of view in the 3D virtual environment while the user walks, the induced translation and/or rotation being absent from vr1. The processor module may be configured to move the point of view in the 3D virtual environment along vr1 taking into account vr2.

In some implementations of the system, the processor module may be configured to define a target multidimensional path in the 3D virtual environment, computing vr2 being performed to match the target multidimensional path while the user walks unidimensionally in the real environment.

In some implementations of the system, the processor module may be configured to segment the moving of the point of view in the 3D virtual environment into multiple frames per second wherein the vectors r1 vr1 and vr2 are computed for each of the multiple frames.

In some implementations of the system, Δx may be a gain applied to a corresponding x component of vr1 the gain Δx being different from 0 and different from 1 Δy is a dynamic gain applied to the corresponding x component of vr1 the gain Δy being greater than 1 when inducing the translation of the point of view in the 3D virtual environment while the user walks and Δθ is greater or equal to 0 and added to the θ component of vr1 Δθ being greater than 0 when inducing the rotation of the point of view in the 3D virtual environment while the user walks.

In some implementations of the system, the gain Δx may be fixed to a value greater than 1 and smaller than 2.

In some implementations of the system, the gain Δy may be dynamically set to a value greater than 1 and smaller than 2 considering at least one of a distance value calculated from the x-component and/or the y-component of r1 and a total rotation value calculated from the θ component of r1 and a maximum value of Δθ is set considering a distance value calculated from an x-component and/or a y-component of r1 and a total rotation value calculated from the θ component of r1.

In some implementations of the system, the processor module may be configured to, to evaluate discomfort of the user in the 3D virtual environment, define a first coefficient is defined as Δθ compared to the distance value, a second coefficient is defined as Δy compared to the distance value. In some implementations of the system, third coefficient may be defined as Δθ compared to the total rotation value and a first coefficient is defined as Δy compared to the total rotation value. In some implementations of the system, computing vr2 may be a computer engineering optimization problem of the first, second, third and fourth coefficients to match the target multidimensional path while the user walks unidimensionally in the real environment.

In some implementations of the system, the user may walk in the real environment on a single-dimension treadmill. In some implementations of the system, the method may further include controlling a motor assembly of the treadmill for moving the user thereon from r1 vr1 and vr2.

In some implementations of the system, the processor module may be configured to trigger the motor assembly to drive the treadmill when a distance between a front limit of the treadmill is within a predetermined dynamic or static threshold.

In some implementations of the system, the processor module may be configured to trigger the motor assembly to stop the treadmill when a distance between a rear limit of the treadmill is within a predetermined dynamic or static threshold.

In some implementations of the system, the processor module may be configured to, when the user walks without triggering the motor assembly to drive the treadmill, Δy has a fixed gain value greater than 1 and Δx has a fixed gain value greater than 1. In some implementations of the system, the processor module may be configured to, when the user walks and triggers the motor assembly to drive the treadmill, Δy has a dynamic gain value greater than 1 and Δx has a dynamic gain value greater than 1.

In some implementations of the system, a speed of the treadmill may be determined to keep the user at a center position of the treadmill.

Still another aspect of the present disclosure relates to a non-transient computer-readable storage medium having instructions embodied thereon, the instructions being executable by one or more processors to perform a method for navigating in a virtual environment considering imprecision from user's inner ear vestibular systems. The method may include defining a three-dimensional, 3D, computer generated virtual environment. The method may include defining a point of view for a user in the 3D virtual environment. The user may have a defined position in a real environment defined using a longitudinal x axis, a lateral y axis and a perpendicular z axis. The method may include, when the user walks in the real environment, defining a vector of movement r1 in the real environment and computing a first vector of movement vr1 in the 3D virtual environment from r1 with vr1 having a component x along the x axis, a component y along the y axis and a rotational component θ around the z axis.

The method may include, in real-time priority processing and while the user walks in the real environment, computing a second vector of movement vr2 in the 3D virtual environment having an x-translation component Δx along the x axis, a y-translation Δy component along the y axis and a rotational component Δθ around the z axis with at least one of Δx, Δy and Δθ being effective for inducing a translation and/or rotation of the point of view in the 3D virtual environment while the user walks, the induced translation and/or rotation being absent from vr1. The method may include moving the point of view in the 3D virtual environment along vr1 taking into account vr2.

In some implementations of the computer-readable storage medium, the method may include further including defining a target multidimensional path in the 3D virtual environment, computing vr2 being performed to match the target multidimensional path while the user walks unidimensionally in the real environment.

In some implementations of the computer-readable storage medium, the method may include further including segmenting the moving of the point of view in the 3D virtual environment into multiple frames per second wherein the vectors r1 vr1 and vr2 are computed for each of the multiple frames.

In some implementations of the computer-readable storage medium, Δx may be a gain applied to a corresponding x component of vr1 the gain Δx being different from 0 and different from 1 Δy is a dynamic gain applied to the corresponding x component of vr1 the gain Δy being greater than 1 when inducing the translation of the point of view in the 3D virtual environment while the user walks and Δθ is greater or equal to 0 and added to the θ component of vr1 Δθ being greater than 0 when inducing the rotation of the point of view in the 3D virtual environment while the user walks.

In some implementations of the computer-readable storage medium, the gain Δx may be fixed to a value greater than 1 and smaller than 2.

In some implementations of the computer-readable storage medium, the gain Δy may be dynamically set to a value greater than 1 and smaller than 2 considering at least one of a distance value calculated from the x-component and/or the y-component of r1 and a total rotation value calculated from the θ component of r1 and a maximum value of Δθ is set considering a distance value calculated from an x-component and/or a y-component of r1 and a total rotation value calculated from the θ component of r1.

In some implementations of the computer-readable storage medium, the method may include further including, to evaluate discomfort of the user in the 3D virtual environment, defining a first coefficient is defined as Δθ compared to the distance value, a second coefficient is defined as Δy compared to the distance value. In some implementations of the computer-readable storage medium, third coefficient may be defined as Δθ compared to the total rotation value and a first coefficient is defined as Δy compared to the total rotation value. In some implementations of the computer-readable storage medium, computing vr2 may be a computer engineering optimization problem of the first, second, third and fourth coefficients to match the target multidimensional path while the user walks unidimensionally in the real environment.

In some implementations of the computer-readable storage medium, the user may walk in the real environment on a single-dimension treadmill. In some implementations of the computer-readable storage medium, the method may further include controlling a motor assembly of the treadmill for moving the user thereon from r1 vr1 and vr2.

In some implementations of the computer-readable storage medium, the method may include further including triggering the motor assembly to drive the treadmill when a distance between a front limit of the treadmill is within a predetermined dynamic or static threshold.

In some implementations of the computer-readable storage medium, the method may include further including triggering the motor assembly to stop the treadmill when a distance between a rear limit of the treadmill is within a predetermined dynamic or static threshold.

In some implementations of the computer-readable storage medium, the method may include, when the user walks without triggering the motor assembly to drive the treadmill, Δy has a fixed gain value greater than 1 and Δx has a fixed gain value greater than 1. In some implementations of the computer-readable storage medium, the method may include, when the user walks and triggers the motor assembly to drive the treadmill, Δy has a dynamic gain value greater than 1 and Δx has a dynamic gain value greater than 1.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

Further features and exemplary advantages of the present invention will become apparent from the following detailed description, taken in conjunction with the appended drawings, in which:

FIG. 1 illustrates a virtual reality system in accordance with a preferred embodiment;

FIG. 2 illustrates a virtual reality treadmill being functionally equivalent to an infinite straight hallway in accordance with a preferred embodiment;

FIGS. 3A and 3B illustrate an exemplary redirected walking technique in accordance with a preferred embodiment and being later referred to as circular redirection;

FIGS. 4A and 4B illustrate another exemplary redirected walking technique in accordance with a preferred embodiment and being later referred to as glide redirection;

FIGS. 5A-5E illustrate a method of walking around a 90 degree corner in a virtual environment while walking along a straight hallway in a real environment in accordance with a preferred embodiment;

FIGS. 6A-6E illustrate a method of walking around a corner in a virtual environment while walking along a straight hallway in a real environment in accordance with a preferred embodiment;

FIGS. 7A-7E illustrate a method of walking around two consecutives 90 degree corners in a virtual environment while walking along a straight hallway in a real environment in accordance with a preferred embodiment;

FIGS. 8A-8C illustrate a method of resizing a hallway of a virtual environment being wider than a corresponding hallway in the real environment in accordance with a preferred embodiment;

FIG. 9 illustrates an exemplary mode of implementation of the circular and the glide redirect techniques of respectively FIGS. 3A-3B and 4A-4B;

FIG. 10 illustrates an exemplary mode of implementation of the redirected walking technique of FIG. 6A-6E; and

FIG. 11 illustrates an exemplary mode of implementation of the redirected walking technique of FIGS. 5A to 5F.

FIG. 12 illustrates a system configured for navigating in a virtual environment considering imprecision from user's inner ear vestibular systems, in accordance with one or more implementations.

FIG. 13 illustrates a method for navigating in a virtual environment considering imprecision from user's inner ear vestibular systems, in accordance with one or more implementations.

### DETAILED DESCRIPTION

The shortcomings of the prior art are generally mitigated by providing a virtual reality system and method being useful in any application field involving virtual simulations such as, but not limited to, entertainment field, educational field, promotional field, professional field and medical field. The method and system presented herein is applicable a wide variety of virtual environments.

In the context of the technology described herein, a user is provided with the capacity to move within a three dimensional (3D) virtual environment. While the 3D virtual environment imposes certain limits (e.g., size limits of the 3D virtual environment, inaccessible sectors thereof, predetermined available path(s), etc.), the user is able to make decisions regarding movements in the 3D virtual environment. Such decisions by the user should be made while maintaining a credible and immersive experience for the user while mitigating possible adverse effects (e.g., dizziness, nausea, imbalance, etc.). In order to achieve this, the present technology takes advantage of imprecision from user's inner ear vestibular systems to lure the user into various types of movements in the virtual environment while, in the real environment, the actual movement is ultimately corrected and reduced to linear movements (e.g., the full size of a treadmill used in the real environment may be taken into account but the user will be redirected considering the characteristics of the treadmill)).

In one aspect, the virtual reality system aims at allowing a user to move around an omnidirectional virtual environment while moving according to a unidimensional path (or one-dimensional path) in the real environment, the user being in control of the speed of movement and, within certain limits imposed in the virtual environment, of the direction of movement.

In another aspect, the virtual reality system aims at allowing the rotation of a virtual environment as a function of a user's movement according to unidimensional path in the real environment.

In another aspect, the virtual reality system aims at allowing the translation of a virtual environment as a function of a user's movement according to unidimensional path in the real environment.

In another aspect, the virtual reality system aims at allowing the rotation of a virtual environment as a function of a user's head rotation in the real environment.

In another aspect, the virtual reality system aims at allowing the translation of a virtual environment as a function of a user's head rotation in the real environment.

In yet another aspect, the virtual reality system aims at simultaneously and/or consecutively allowing the rotation and the translation of a virtual environment as a function of a user's head rotation in the real environment and/or a user's movement according to unidimensional path in the real environment.

In a further aspect, the virtual reality system aims at adjusting the user's position in the real environment after overpassing a curved path in the virtual environment.

In a further aspect, the virtual reality system aims at allowing the offset of the user's position in the real environment in order to prepare to a curved path in the virtual environment using various redirected walking techniques.

In yet a further aspect, the virtual reality system aims at allowing a user to be moving in a virtual environment being wider than the real environment wherein the user is moving according to a unidimensional path.

In another aspect, the virtual reality system aims at allowing a user to move around curves and corners of any nature or to make a U-turn in a virtual environment while moving according to a unidimensional path in the real environment.

In yet another aspect, the virtual reality system comprises a unidimensional treadmill allowing the user to be moving according to a unidimensional path in the real environment.

In yet another aspect, the virtual reality system comprises an omnidirectional treadmill allowing the user to be moving according to at least one unidimensional path in the real environment.

Other and further aspects and advantages of the present invention will become apparent upon an understanding of the illustrative embodiments described and/or claimed herein, and various advantages not referred to herein will occur to one skilled in the art upon practice of one or more embodiments thereof.

Although the invention is described in terms of specific illustrative embodiments, it is to be understood that the embodiments described herein are by way of example only and that the scope of the invention is not intended to be limited thereby.

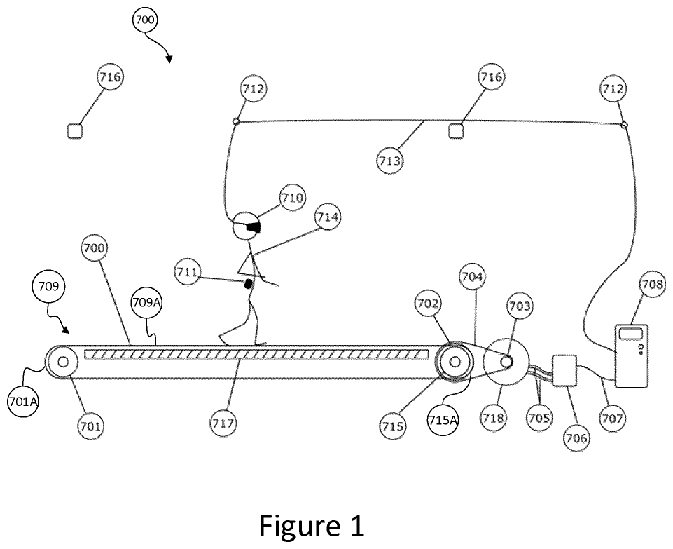

Referring is now made to the drawings in which FIG. 1 exemplifies an embodiment of a virtual reality system 700. The system 700 comprises a virtual reality treadmill 709 being configured to allow a unidimensional movement. In the depicted example, the treadmill 709 is limited to forward and/or backward movement. The treadmill 709 is preferably configured to allow a user 714 to be moving in a single horizontal direction. The treadmill 709 comprises two extremities 701A and 715A adapted to receive each a free rotating member, 701 and 715, being preferably a cylinder. The treadmill 709 further comprises a moving belt 709A being adapted to engage from each extremity the rotating cylinders 701 and 715 and being running over a treadmill support frame 717 being located in between the rotating cylinders 701 and 715.

Still referring to FIG. 1, the virtual reality system 700 further comprises at least one motor 718 being coupled to the rotating member 715 by the mean of a belt 704. The at least one motor 718 is adapted to be connected to at least one motor controller 706 and the motor controller 706 is connected to a computing unit 708 comprising at least one processor.

Understandably, the activation of the motor 718 triggers a rotation movement of the rotating cylinder 715 which triggers the rotation movement of the moving belt 709A over the rotating cylinders. The rotation movement of the moving belt 709A corresponds to a unidirectional translation of the user 714 over the treadmill support frame 717. In the context of the virtual system 700, an actual walking speed of the user on the treadmill 709 is dynamic considering choices made by the user in the virtual environment (e.g., stopping, decelerating, accelerating). Speed of the moving belt 709A is determined dynamically by the combination of the motor controller 706 and the computing unit 708.

Understandably, although an exemplary treadmill 709 is illustrated, any treadmill allowing at least one unidimensional path movement may be adapted to be in use with the present virtual reality system 700.

Still referring to FIG. 1, the virtual reality system 700 comprises at least one device or device assembly adapted to be attached to the user 714 in order to communicate information towards/from the user 714 from/towards the computing device 708. For instance, the at least one device or device assembly may be used to allow a determination, in real-time, of an actual position of the user in the real environment. In other embodiments, sensors may be used to determine the actual position. The at least one device or device assembly may also be used to provide images of the virtual environment to the user, which may be replaced or complemented by display screens in the real environment (e.g., partially or completely surrounding the user in the real environment).

In a preferred embodiment, the device or device assembly mentioned above for the system 700 may comprise a head mounted display 702 (named HMD herein after) or headset 710, and at least one tracking system 711 being both adapted to be worn by the user and operatively connected to the computing unit or computer 708. In the present context, “operatively connected” indicates that one or more wired and/or wireless communication link is provided towards the computing unit 708. The communication link may be provided as a direct connection therebetween or may involve one or more intermediate nodes (e.g., switch, router, etc.) as long as the quality of communication (e.g., delay, jitter, etc.) incurred by the communication link is acceptable in the context of the real-time processing required in the virtual system 700 (i.e., to maintain the target level of immersivity and/or credibility. The HMD 702 or headset 710 is adapted to receive information from the computing device 708 to project images of the virtual environment to the user 714, considering actions of the user therein. The tracking system 711 allows communicating the position of the user 714 to the computing device 708.

In the preferred embodiment illustrated on FIG. 1, the wires 713 connecting the headset 710 to the computing device are supported by the ceiling above the treadmill 709 using attachment points 712. Other configurations or types of connection can be used as long as the connections do not interfere, in practice, with the movements of the user on the treadmill 709.

As illustrated on FIG. 1, the tracking system 711 is attached to the user's belt. Understandably, the tracking system 711 can be adapted to be placed anywhere on the user's body and/or comprise additional external sensors to track the user's position. Skilled persons will readily understand that the tracking system 711 only represent an exemplary system to capture position of the user and that different solutions could be used as long as the frequency of position measurement (e.g., every 100 ms) and type of measurement (e.g., number of data points available) are sufficient in the context of the depicted embodiments.

Understandably, the tracking system 711 may be not attached to the user. Thus, a sensor system involving one or more of cameras, lasers, ultrasound or other means may be used to determine the user's position.

In another embodiment, both the tracking system 711 and the HMD 702 or headset 710 may be adapted to be integrated into a single device being configured to communicate information towards/from the user 714 from/towards the computing device 708. In other words, the tracking system 711 can be incorporated into the HMD 702 or headset 710 to provide just one device to be worn by the user.

Understandably, the computing device 708 may be replaced with any equivalent device in another form (tablet, phone, etc.) or integrated into the motor controller 706 or into the HMD 702 or headset 710.

Still referring to FIG. 1, the tracking system 711 can be configured to communicate the user's position to the computing device 708 following a unidirectional movement of the user, being preferably a forward or backward movement on the moving belt 709A. The computing device 708 communicates commands to the one or more motor controller 706 according the user's position in order to regulate/control the rotation of the motor 718. The motor 718 regulates (increase, decrease or reverse) the moving belt's speed making sure that the user keeps moving as expected. The exact control algorithm may vary with different applications and types of users.

In another embodiment, the virtual reality system 700 may further comprise safety devices in order to safely operate the treadmill 709.

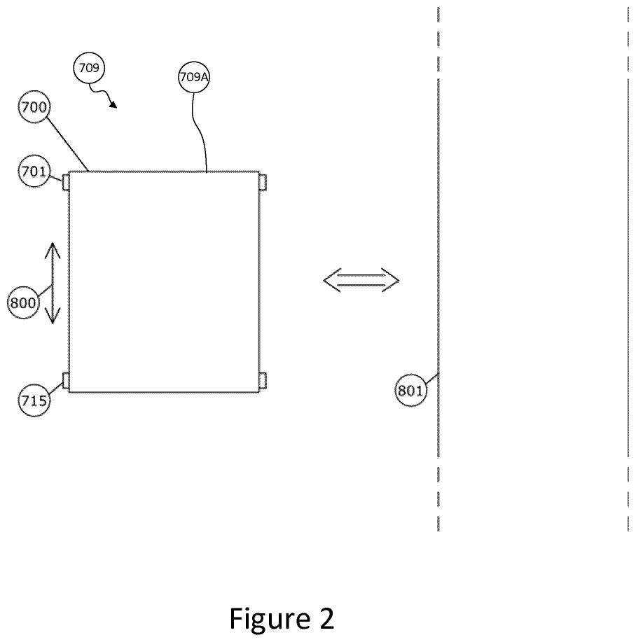

Referring now to FIG. 2, an embodiment of a virtual reality treadmill 709 is illustrated. The treadmill 709 is preferably configured to allow a unidimensional movement 800 in both forward and backward directions. Such a configuration allows a user to move indefinitely according a unidimensional path. In such configuration, the treadmill 709 becomes functionally equivalent to an infinite hallway 801, which has a width that is at least as wide as the moving belt 709A.

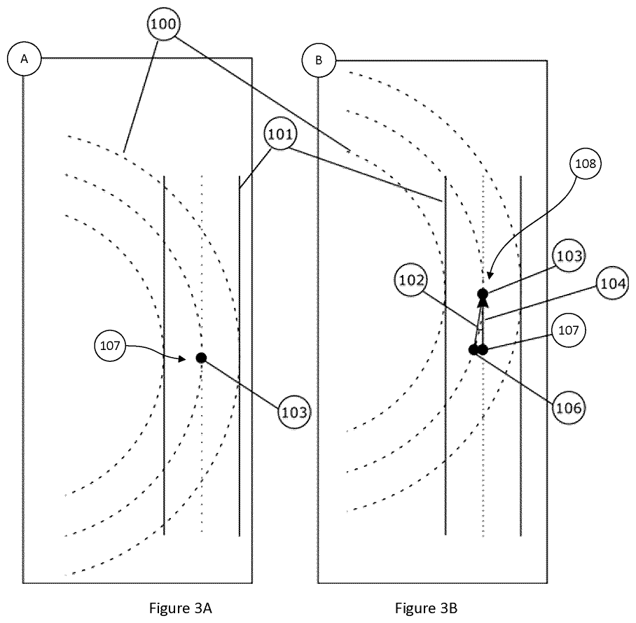

FIGS. 3A and 3B illustrates an exemplary embodiment of a redirected walking technique being referred to further as circular redirection technique. In the circular redirection technique, the virtual environment 100 is rotated as a function of the translation of the user 103. FIG. 3A illustrates a starting position 107 of the user 103 and FIG. 3B illustrates an ending position 108 of the user 103 after a single time step or single frame.

Referring further to FIG. 3B, the rotation of the virtual environment by an angle 102 is synchronized and coordinated in real-time with the unidirectional rectilinear movement 104 of the user 103 in the real environment 101. Thus, the user's initial position 107 in the real environment is no longer the same as his initial position 106 in the virtual environment. Such a circular redirection technique allows establishing a linear function between the user's forward/backward rectilinear movement 104 in the real environment and the angular rotation 102 in the virtual environment.

In the present context, such a circular redirection technique allows either a rough mapping of a straight hallway 101 in the real environment into a circular hallway 100 in the virtual environment (as illustrated) or a rough mapping of a circular hallway in the real environment into a straight hallway in the virtual environment (not illustrated).

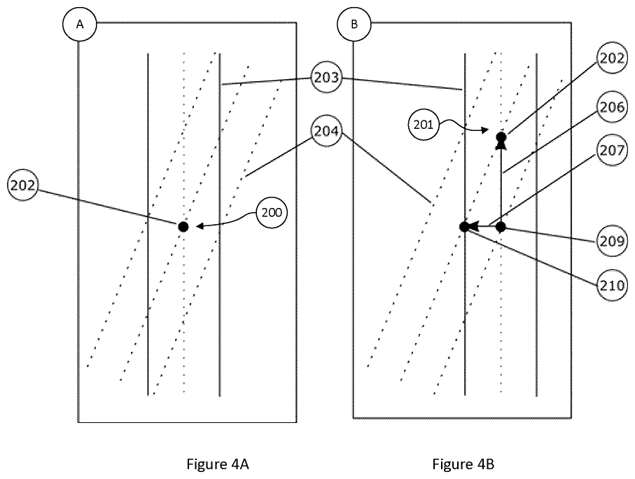

FIGS. 4A and 4B illustrate another exemplary embodiment of a redirected walking technique being referred to further as “glide redirection technique”. In the glide redirection technique, the virtual environment 204 is translated as a function of the translation of the user 202. In this exemplary embodiment, the virtual environment 204 is translated in a direction 207 being substantially perpendicular to the forward linear movement 206 in the real environment 203. FIG. 4A illustrates a starting position 200 of the user 202 and FIG. 4B illustrates an ending position 201 of the user 202 after a single time step.

Referring further to FIG. 4B, the translation 207 of the virtual environment 204 is instantly synchronized and coordinated with the rectilinear movement 206 of the user 202 in the real environment 203.

For any redirected walking technique of any of FIGS. 1-11, the hallway in the virtual environment may not be strictly defined. Thus, in an open virtual environment, the virtual environment may be defined by visual cues, waypoints or by objects serving as such. The hallway may be defined by interpreting the user's past behavior and predicting user's future behavior. The hallway in the virtual environment may further be defined by walls, cliffs, carpets, pathways, fences, waypoints, visual overlays, audio cues, animated characters or any other means or objects that is appropriate for a given virtual environment. Skilled persons will understand that the manner in which a path is defined is not limited. For instance a path may be defined by as a virtual hallway with virtual walls, causing the user (or player) to walk therealong. In some other instances, the user or player may be enticed into following a character “showing” the path to follow. In some other instances, more than one path may be offered to the user and selected dynamically (e.g., though behavioral analysis and/or scenario based decision-making)

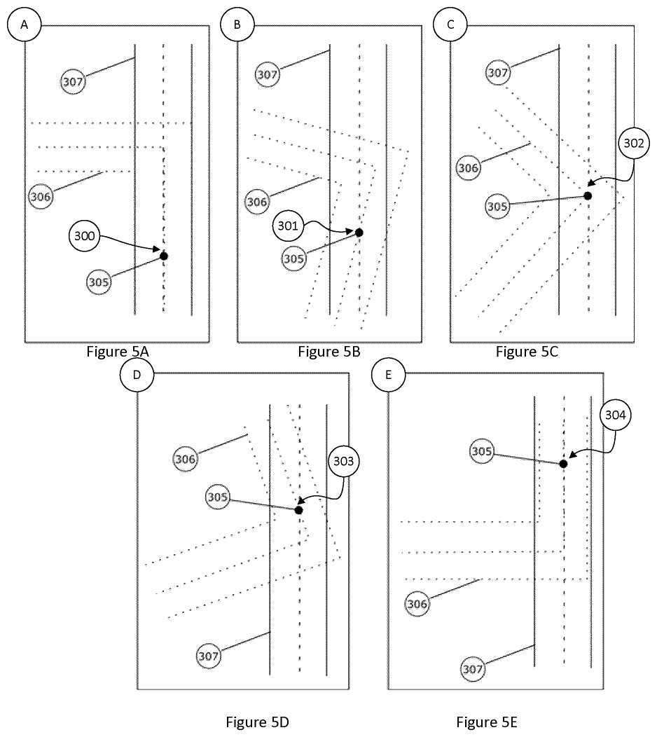

FIGS. 5A-5E illustrate a preferred embodiment of a method of walking around a 90 degree corner in a virtual environment while walking along a straight hallway in a real environment. The redirected walking technique consists in, at an instant synchronization, the coordination between circular and glide redirection techniques and both with the user 305 unidirectional rectilinear movement. Such a redirected walking technique allows providing a comfortable and stable virtual immersion experience when a user 305 is walking around a corner, preferably but not limited to a 90 degree corner, in a virtual environment 306 while walking along a straight hallway 307 in a real environment.

In this preferred embodiment, FIGS. 5A-5E illustrates four time steps (or four frames) for a total of five consecutive states; respectively illustrated as 300, 301, 302, 303 and 304.

Referring now to FIG. 5B, the virtual environment 306 may be rotated as a function of the translation of the user 305 in accordance with the principles of the circular redirection technique of FIGS. 3A-3B. The rotation of the virtual environment 306 would normally displace the user 305 in a side way of the hallway in the real environment 307, being in the right side of the hallway in the present illustrated embodiment.

Referring now to FIG. 5C, in order to avoid the side way displacement of the user 305 in the hallway 307 in the real environment, the virtual environment 306 of FIG. 5B is being translated in the opposite side way in which the user 305 would be eventually displaced, the right side in the present embodiment. The virtual environment 306 is being laterally translated as a function of the longitudinal rectilinear movement of the user 305 in accordance with the principles of the glide redirection technique of FIGS. 4A-4B.

Still referring to FIG. 5C, the instant synchronization and coordination between circular and glide redirection techniques and both with the user 305 rectilinear movements, results in the user 305 being exactly centered in both the hallway 306 in the virtual environment and the hallway 307 of the real environment.

Understandably, such a redirect walking technique, combining both the circular and glide redirection walking, involves defining the relative position of the center line of the hallway 306 in the virtual environment accordingly to the center line of the hallway 307 in the real environment at each current position of the user 305. Such relative position between both center lines roughly defines the drift required to make the user 305 centered in both the hallway 306 in the virtual environment and the hallway 307 of the real environment. It is possible to determine functions between the movement of the user in the real environment and the maximum rotation and/or translation induced in the 3D virtual environment that allow for maintaining a credible and immersive experience for the user (more information is provided hereinbelow with regards to exemplary coefficients defined for that purpose). The value of allowable and required drift, making comfortable the virtual immersion experience, is dependent on the application field, on the user's movement and speed and the nature of the curve. Depending on the physical layout of the real environment (e.g., dimensions of the treadmill 709 or “real” room in which the user moves).

Understandably, the hallways in the virtual and the real environments do not have to be perfectly aligned. There can be a difference between the center of the virtual hallway and the center of the real hallway which is referred to as drift. The accessible width (w) of the virtual hallway in relation to the width of the treadmill (tw) and gain (g) can be defined as w=tw*g. Therefore, if the width of the virtual hallway is narrower than the accessible width, then it is possible to offset the centers of the virtual hallway and the real hallway by the difference with no loss of accessibility in the virtual world. Even when the width of the virtual hallway is larger than the accessible width, an offset can be allowed and sometimes desired but it may lead to loss of accessibility in the virtual world. For instance it is often assumed, when the user is expected to walk around a corner, that the user will not attempt to stand in the exact far corner of a hallway. For comfort, the algorithm is therefore allowed to drift toward the inside of the corner, thus disabling access to the outer corner of the hallway. This allows the corner to be more comfortable and less noticeable.

The FIGS. 5A-5E illustrate perfectly centered hallways but the implementation will sometimes allow drift (i.e., actual translation of the user on the treadmill 709) to better accommodate the user.

Referring further to FIGS. 5D-5E, repeating consecutively the circular and the glide redirection techniques while the user keeps moving in a straight linear direction allows, as detailed below for FIGS. 5B-5C, the user 305 to be exactly centered in both the hallway 306 in the virtual environment and the hallway 307 of the real environment after accomplishing a complete 90 degree turn in the virtual environment 306 while keeping a straight rectilinear unidirectional movement in the real environment 307.

Understandably, the redirect walking technique illustrated in FIGS. 5A-5E is adapted to any corner, curve, angle, and any combinations of all these elements in a virtual environment.

Understandably, the time steps 300, 301,302, 303 and 304 are shown only for the sake of clarity in illustration. In the application, the time between steps or frames may vary, the number of time steps or frames may vary and the implementation may be done with a continuous computation method. In practice, a user walking around a corner could span approximately 1000 frames. For the sake of clarity and for illustration purposes, only 5 sample frames are shown in the set of drawings. Although it may prove impractical, it is theoretically possible to provide a continuous system with infinitesimal frames/time-steps.

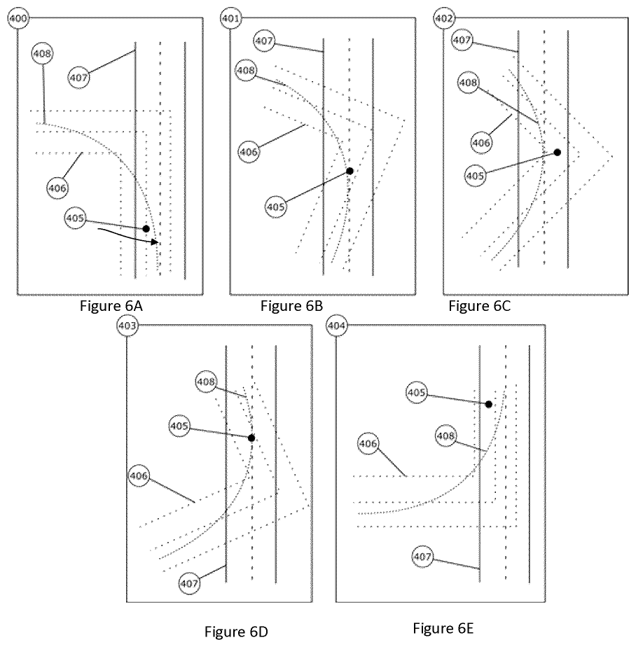

FIGS. 6A-6E illustrate a method of walking around a curve in a virtual environment while walking along a straight hallway in a real environment. Such a redirect walking technique allows providing a comfortable and stable virtual immersion experience when a user 405 is walking around a curve 408 in a virtual environment 406 while moving along a straight hallway 407 in a real environment.

In the illustrated embodiment, FIGS. 6A-6E depicts four time steps (or frames) for a total of five consecutive states; respectively being steps 400, 401, 402, 403 and 404.

Referring to FIG. 6A, the virtual environment 406 is being intentionally side shifted relatively to the center line of the real environment 407 in order to keep the curve 408 centered in the hallway of the real environment. In this preferred embodiment, the user 405 is moving according the center line of the virtual environment 406 and on the side of the center line of the hallway in the real environment 407.

Understandably, getting the user 405 in the position of step 400 may be achieved through any number of redirected walking techniques such as glide redirection, circular redirection, rotational gain or any other redirected walking techniques. As can be seen in 400, the virtual hallway is offset from the real hallway. This may be the results of a number of different events:

1. Start position for the experience;

2. The virtual environment hallway was centered and the real environment hallway were centered N frames ago and a glide redirection over N frames has taken place to offset the virtual environment hallway from the real environment hallway;

3. The virtual environment hallway and the real environment hallway were centered N frames ago and a circular redirection in one direction has taken place to start moving to one side and a second circular redirection in the other direction has taken place to regain parallelism.

4. Any other redirected walking technique described herein;

5. A simultaneous combination of 2, 3 and 4.

6. A sequential combination of 2, 3 and 4.

7. A sequence of various combinations of 2, 3 and 4.

In the depicted embodiment, the side shifting of the virtual environment allows to compensate the fact that the user 405 will drift towards the right of the hallway 407 in the real environment throughout the curve 408 (see FIG. 6C). Such a technique allows the curve to be performed over a longer distance, thus artificially increasing the radius of the curve 408 and therefore increasing the comfort of the user or making the redirection imperceptible to the user. The radius of a corner, by definition, is nil. By progressively turning the user's perspective over a longer distance, the radius of the circle followed by the player is naturally greater than 0. The radius of the curve is directly related to the user's comfort.

Referring now to FIGS. 6D-6E, the curve 408 may be initiated at a later time but extended over a longer distance by deliberately increasing the turning radius of the curve 408. Such a technique cause a user 405 centered in the virtual environment to drift toward the left of the hallway 407 in the real environment.

Understandably, following the curve, the user may be re-centered in the hallway in the real environment by using any combination of redirected walking techniques.

In another embodiment, the redirect walking technique of FIGS. 6A-6E may also be used to attenuate the turning radius of any defined path.

Understandably, the time steps 400, 401,402, 403 and 404 are shown only for the sake of clarity in illustration. In the application, the time between steps may vary, the number of time steps may vary and the implementation may be done with a continuous computation method.

Understandably, the redirect walking technique illustrated in FIGS. 6A-6E is adapted to any corner, curve, angle, and any combinations of all these elements in a virtual environment.

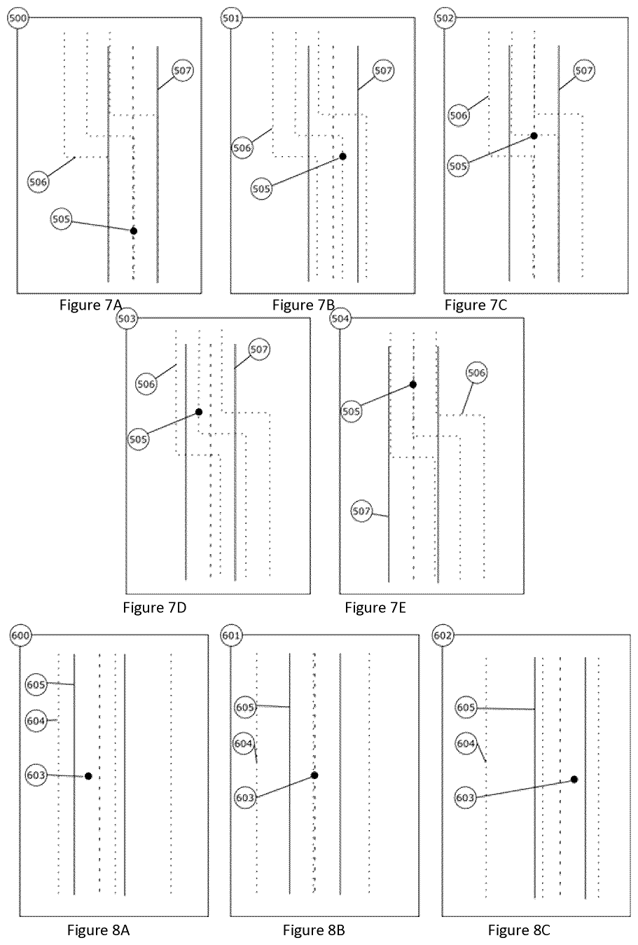

Referring now to FIGS. 7A-7E, a preferred embodiment of a method of walking around two consecutives 90 degree corners in a virtual environment while walking along a straight hallway in a real environment is illustrated. The illustrated technique allows providing a comfortable and stable virtual immersion experience when a user 505 is moving around two consecutives corners, preferably but not limited to 90 degree corners, in a virtual environment 506 while walking along a straight hallway 507 in a real environment.

In this preferred embodiment, FIGS. 7A-7E illustrates four time steps (or frames) for a total of five consecutive states; respectively being 500, 501, 502, 503 and 504.

Referring to FIG. 7A, the user 505 is moving straight according to a linear unidirectional movement while being centered in both the hallway 506 in the virtual environment and the hallway 507 of the real environment.

Referring now to FIG. 7B, the virtual environment 506 is being translated in a direction substantially angled, preferably perpendicular, to the user's moving direction when the user 505 approaches a first turn in the virtual environment 506. Such a glide redirection technique keeps the user 505 centrally positioned relatively to the real environment while being side shifted between both turns of the virtual environment 506 (see FIG. 7C). Such a glide redirection technique is applied in order to align the last segment of the virtual environment hallway with the center line of the real environment hallway. The illustrated redirect walking technique consists at an instant synchronization and coordination between glide redirection technique and the user 505 rectilinear movement. Skilled persons will understand that the user does not have to stay absolutely center in the real environment hallway as the hallway sides are explored.

Referring now to FIG. 7C, the virtual environment 506 is still being side shifted in a direction substantially angled, preferably perpendicular, to the user's moving direction when the user 505 approaches a second turn in the virtual environment 506. Such a glide redirection technique renders the user 505 centrally positioned relatively to the virtual environment 506 while being side shifted in the real environment 507 (See FIG. 7D). Such a glide redirection technique is applied in order to align the center line of the virtual environment hallway 506 with the center line of the real environment hallway 507.

Understandably, the glide redirection technique applied in FIGS. 7A-7E allows the user 505 to move around two consecutives corners, preferably but not limited to 90 degree corners, in a virtual environment 506 while moving along a straight hallway 507 in a real environment.

The glide redirection technique may be applied over a long ora short distance depending on the user's level of comfort. When the glide redirection technique is used over a short distance, it increases the probability of discomfort for the user. The aggressiveness of the glide (ag) relative to the desired offset (o) and the distance (d) over which this offset will be applied may be defined as ag=o/d. Thus, shorter distances relative to the desired offset will cause an increase in the discomfort of the user. The severity of this discomfort will vary as a function of the user physiology and application. For instance, high aggressiveness could be determined to be unacceptable for rehabilitation purposes (e.g., as it could throw off the patient's gait), but could be acceptable in gaming or entertainment contexts.

In another embodiment, the first and the last segments of the virtual environment hallway may not be always parallel. In such a configuration, the glide redirection technique of FIGS. 7A-7E may be combined to the circular redirection technique of FIGS. 3A-3b to achieve the same result as FIGS. 7A-7D.

The time steps 500, 501,502, 503 and 504 are shown only for the sake of clarity in illustration. In the application, the time between steps may vary, the number of time steps may vary and the implementation may even be done with a continuous computation method.

FIGS. 8A-8C illustrate a preferred embodiment of a virtual environment resizing technique. The present technique allows increasing the apparent size of the hallway 604 of the virtual environment without modifying the size of the real environment wherein the user is located. Said differently, a gain is applied, in the virtual environment, on one or more actual dimensions of the real environment. The gain may be static or may de dynamic as will be exemplified hereinbelow. Such a technique allows obtaining a hallway in the virtual environment 604 being wider than the hallway in the real environment 605.

In this preferred embodiment, three states 600, 601 and 602 showing the user's positions are illustrated. These states are unordered and are shown only for the sake of clarity in illustration. As a skilled person will readily recognize an actual system may provide an infinite number of states as the user moves across the hallway in the virtual environment 604.

Still referring to FIGS. 8A-8C, the virtual environment 604 is continuously translated in the opposite direction of the movement direction of the user offering a better visual field to the user in the virtual environment and allowing the user to access areas in the virtual environment that would otherwise be impossible to access.

Understandably, as the user 603 moves east, the virtual environment 604 is translated west as a function of the user's movement and vice-versa.

The function used to link the virtual environment translation to the user's movement is preferably linear. However, non-linear functions may also be used to increase the user's comfort under some circumstances. For example, the gain may typically be defined as g where movement (v) in any direction in the real environment will result in movement (vr) such that (yr=g*v). However, an infinite number of polynomial relations can be used to approximate this and non-linear relations may also be appropriate. For instance, when the user remains centered in the real environment hallway, the gain (or gain equivalent) will remain low. As the user approaches the side of the hallway, the gain (or gain equivalent) is increased to trade off comfort for virtual environment accessibility. Obviously, this is no longer a linear relation.

Understandably, the virtual environment resizing technique illustrated in FIGS. 8A-8C is adapted to any corner, curve, angle, and any combinations of all these elements in a virtual environment.

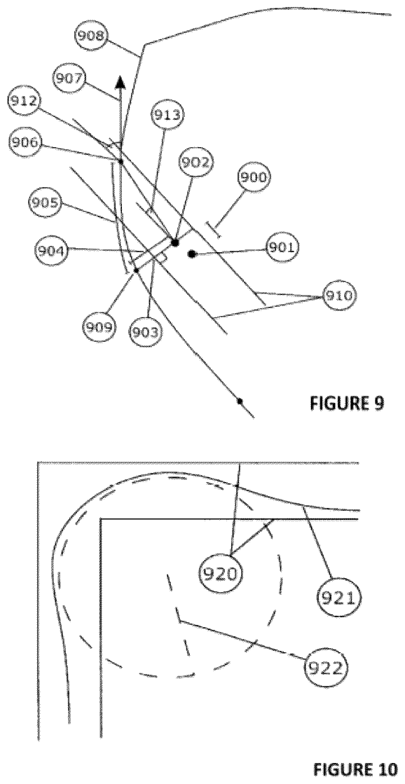

FIG. 9 illustrates a preferred embodiment of a method of implementation of the circular and the glide redirect techniques. Such a method of implementation aims at keeping the hallway 910 in the real environment aligned with the path 908 of the virtual environment while ensuring a comfortable virtual immersion experience to the user being moving in a rectilinear unique direction.

The method illustrated in FIG. 9 may comprise the following steps:

measuring the displacement 900 in a real environment of a user being in rectilinear movement from an initial position 901 to another position 902; the measured displacement will be referred to as dz hereinbelow;

projecting the user's position 902 in a substantially perpendicular direction to the direction of the hallway 910 and laterally across the hallway 910 in the real environment onto the path 908 in the virtual environment so as to obtain a first position 909 on the path 908;

measuring the distance between the first position 909 and the center line of the hallway 910 in the real environment, the measured distance will be referred to as Ex hereinbelow, and is representative of the lateral path error to be corrected;

defining a second position 906 on the path 908 by applying a dimensional parameter 905 to the first position 909;

defining an angular parameter 912 representing the angle between the tangent 907 to the path 908 at the second position 906 and the linear forward direction of the hallway of the real environment 910; the angular parameter 912 will be referred to as Er hereinbelow and is representative of the rotational path error to be corrected;

using the circular redirecting technique, as described in FIGS. 3A-3B, to correct the rotational path error Er by applying a rotational path correction coefficient to rotate the virtual environment around the user's position 902 in the real environment. For instance, when the virtual hallway is a perfect circle the objective is to follow its radius. The radius can be redefined as the angle rotated per unit of distance the user has moved. From this, it is possible to correct for the circular path dynamically by measuring an error relative to the path and correcting for it by rotating the camera a number of degrees per unit of movement;

using the glide redirecting technique, as described in FIGS. 4A-4B, to correct the lateral path error Ex by applying a lateral path correction coefficient to translate the virtual environment substantially perpendicularly to the hallway 910 in the real environment; and

repeating the previous steps to each frame as the user progresses along path 908 of the virtual environment.

Understandably, the rotational path error Er may also be determined by defining a second angular parameter 913 representing the angle between the hallway in the real environment's forward direction and the line segment connecting the user's position 902 to the second position 906 on the path 908.

Understandably, a combination of both angular parameters 913 and 912 may also be used to define the rotational path error Er.

Understandably, applying a dimensional parameter to the first position 909 aims at making the virtual reality system predictively begin rotating path ahead of time according to the current position of the user in the real environment. The dimensional parameter may be fixed or variable value depending in the user's position relatively to the path 908. The dimensional parameter should be configured in a way to ensure a comfortable virtual immersion to the user when approaching any particular path 908, such as a curve.

The method illustrated in FIG. 9 may further comprise the steps of:

defining a rotational path correction coefficient being the result of dividing the rotational path error Er (radians) by the dimensional parameter 905 (a distance) and then multiplying the result by the linear displacement 900 (dz) of the user;

defining a lateral path correction coefficient being the result of multiplying the lateral path error Ex (a distance) by the linear displacement 900 (dz) of the user and then by a configuration parameter Ax; the Ax parameter is configured to allow as much as possible the user's comfort while translating the virtual environment in a direction being perpendicular to the user's displacement direction.

Understandably, the lateral path correction coefficient aims at smoothly translating the virtual environment in a direction being perpendicular to the user's displacement direction while minimising a user's discomfort.

In the present embodiment, the larger the configuration parameter is, the longer the path 908 and the hallway 910 in the real environment stays to each other but the least comfortable the user becomes. In the present embodiment, the larger the configuration parameter Ax is, the closer the path 908 and the hallway 910 in the real environment will stay to each other but the least comfortable the user becomes. Said differently, a trade-off exists between comfort and how accurately the virtual hallway and the real hallway stay aligned. Let's take a look at two extremes:

If we want to maximise the user's comfort, we disable any redirection and make it impossible for the user to follow any curves in the path. This is dysfunctional as the user will not be able to follow any paths in the virtual environment but we guarantee comfort.

If we want to maximise the accessibility of the virtual environment by keeping the virtual hallway and the real hallway perfectly aligned, we can do exactly that. This is dysfunctional because the virtual world will turn suddenly at any corner causing nausea, loss of balance and disorientation.

Between these two cases, there is a balanced design where the user remains comfortable but where the user can still explore the virtual environment. The balanced design is expected to change based on context and demographics. For instance, a more comfortable design may be provided to older crowds and a more flexible/“accurate to path” design may be provided for games when more movement are required and/or for a younger crowd.

In another embodiment, the lateral path correction coefficient may be generated from any function that relates the lateral path error Ex by the linear displacement 900 (dz) of the user. Additional variables may also be added to the function. The lateral path error is how far away the center of the real hallway is from the center of the virtual hallway. Coefficients used to rotate the hallway or used to slide the hallway (translation) can be derived from this measured error. A simple example would be a proportional relation between the error and the slide redirection. This implementation may be imperfect, but may still work in a number of circumstances that skilled persons will be able to identify.

In another embodiment, the rotational path correction coefficient may be generated from any function that relates the rotational path error Er (radians) and the linear displacement 900 (dz) of the user or any function that relates the rotational path error Er (radians), the dimensional parameter 905 (a distance) and the linear displacement 900 (dz) of the user. Additional variables may also be added to the function.

In another embodiment, if the rotational path correction coefficient is being relatively large, thus causing discomfort to the user, snap turns may be used to instantaneously rotate the virtual environment instead of rotating it progressively.

Understandably, although the principles of the method of FIG. 9 are detailed hereinabove for a user being in a forward linear movement in the real environment, the same principles are applicable to a user being in a backward linear movement in the real environment. The principles of the method of FIG. 9 are applicable once a user is moving in unidirectional movement.

FIG. 10 illustrates an exemplary mode of implementation of the redirected walking technique of FIG. 6A-6E. The virtual hallway 920 comprises a corner to the right. Prior to the corner, the real path 921 of the user is shifted to the bottom side of the virtual hallway 920. As the path 921 goes around the corner, the path 921 moves from the left side of the hallway to the right side, thus increasing the equivalent turning radius 922 of each path segment. As the path 921 exits the curve, it moves back toward the left side of the hallway, before progressively re-centering itself.

Understandably, the redirect walking technique of FIG. 10 being combined to the method illustrated in FIG. 9 allows reducing both the lateral and rotational path errors and thus increasing the user's comfort.

Understandably, the redirect walking technique illustrated in FIG. 10 is adapted to any corner, curve, angle, and any combinations of all these elements in a virtual environment.

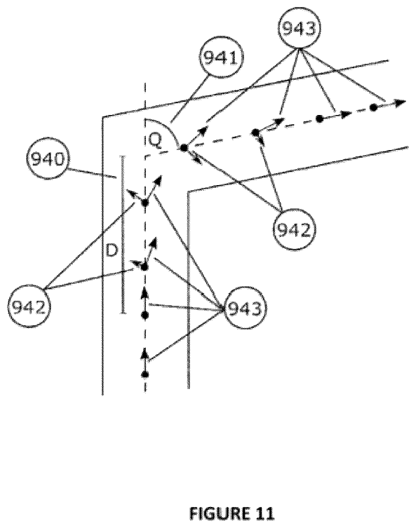

FIG. 11 illustrates an exemplary mode of implementation of the redirected walking technique of FIGS. 5A and 5B. This implementation relies on a predefined redirected walking pattern which will occur as a function of the user's position along the path. For simplicity sake, distance 940 will be referred to as D and angle 941 will be referred to as Q.

Still referring to FIG. 11, when a user is at a distance D from the corner defined by an angle of Q degrees, the virtual environment is being rotating by Q/(2D) degrees per unit of progress along the hallway. Such a rotation of the virtual environment results into pulling a user into the center of the turn. In order to compensate the user's displacement, the virtual environment is being translated. The lateral translation of the virtual environment 942, referred to herein after as dx, is computed as a function of the current angle, θ, being defined as the angle between the path segment of the user and the forward direction of the hallway 943, dz. The relation will be the following: dx=(dz)(tan(θ)).

It is interesting to note that the angle θ will reverse itself as the user moves past the corner of the hallway.

Referring to FIGS. 1-11, the present technology may be used for allowing a user to move around an omnidirectional virtual environment while moving according to a unidimensional path in the real environment. Such a method may comprise the steps of:

activating a unidirectional treadmill of a virtual reality system;

activating a computing device of the virtual reality system to communicate information from/towards a user towards/from the unidirectional treadmill; the computing device allows:

detecting the user's initial position on the treadmill;

measuring the unidimensional displacement 900 in a real environment of a user over the treadmill, the user being in rectilinear movement from an initial position 901 to another position 902; the measured displacement will be referred to here below as dz;

projecting the user's position 902 in a substantially perpendicular direction to the direction of the hallway 910 and laterally across the hallway 910 in the real environment onto the path 908 in the virtual environment as such to obtain a first position 909 on the path 908;

measuring the distance between the first position 909 and the center line of the hallway 910 in the real environment, the measured distance will be referred to here below as Ex and is representative of the lateral path error to be corrected;

defining a second position 906 on the path 908 by applying a dimensional parameter 905 to the first position 909;

defining an angular parameter 912 representing the angle between the tangent 907 to the path 908 at the second position 906 and the linear forward direction of the hallway of the real environment 910; the angular parameter 912 will be referred to here below as Er and is representative of the rotational path error to be corrected;

using the circular redirecting technique, as described in FIGS. 3A-3B, to correct the rotational path error Er by applying a rotational path correction coefficient to rotate the virtual environment around the user's position 902 in the real environment;

using the glide redirecting technique, as described in FIGS. 4A-4B, to correct the lateral path error Ex by applying a lateral path correction coefficient to translate the virtual environment substantially perpendicularly to the hallway 910 in the real environment;

continuously translating the virtual environment in the opposite direction of the movement direction of the user offering a better visual field to the user in the virtual environment and allowing the definition of a virtual environment being larger than the width of the treadmill; and

repeating the previous steps to each frame as the user progresses along path 908 of the virtual environment.

Still referring to FIGS. 1-11, the method for allowing a user to move around an omnidirectional virtual environment while moving according to a unidimensional path in the real environment; may further comprise the steps of:

defining a rotational path correction coefficient being the result of dividing the rotational path error Er (radians) by the dimensional parameter 905 (a distance) and then multiplying the result by the linear displacement 900 (dz) of the user;

defining a lateral path correction coefficient being the result of multiplying the lateral path error Ex (a distance) by the linear displacement 900 (dz) of the user and then by a configuration parameter Ax; the Ax parameter is configured to allow as much as possible the user's comfort while translating the virtual environment in a direction being perpendicular to the user's displacement direction;

The method for allowing a user to move around an omnidirectional virtual environment while moving according to a unidimensional path in the real environment; may further comprise the step of:

Controlling the movement of the treadmill of the virtual reality system according the position, speed and movement of the user.

The methods herein disclosed may also apply to simplifying the mechanical design of an omnidirectional treadmill. The simplest form of an omnidirectional treadmill is the unidimensional treadmill illustrated in FIG. 7. In some embodiments, the unidimensional treadmill may be enhanced by the use of additional actuators thus giving it additional degrees of freedom. In some embodiments, these additional degrees of freedom lead to partial or complete omnidirectional motion.

In this context, partial omnidirectional motion is defined as omnidirectional motion wherein the degree of freedom allowing the user to move laterally is limited in regards to travel, acceleration, speed or otherwise.

In this context, complete omnidirectional motion is defined as omnidirectional motion wherein the second degree of freedom, which allows the user to move laterally behaves similarly to the first degree which allows the user to move longitudinally.

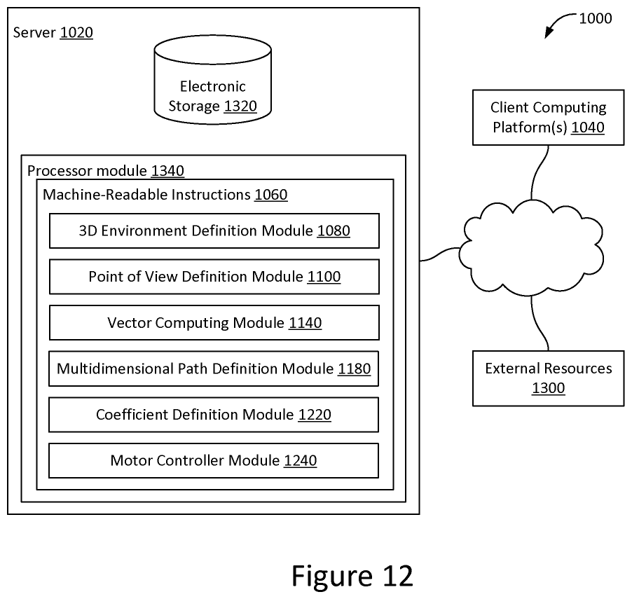

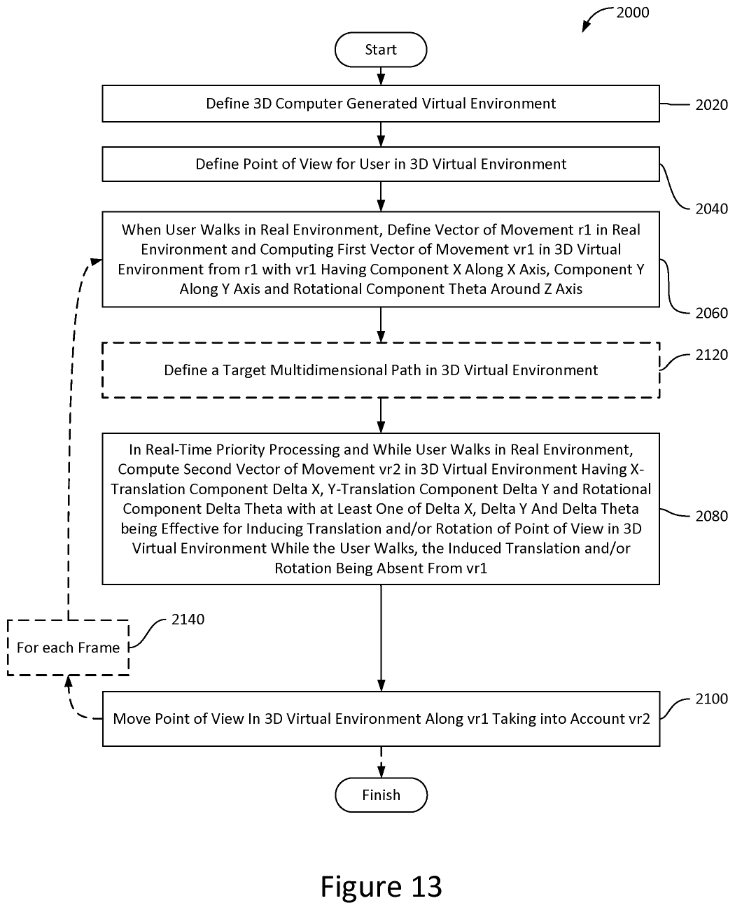

FIG. 12 illustrates a system 1000 configured for navigating in a virtual environment considering imprecision from user's inner ear vestibular systems, in accordance with one or more implementations. In some implementations, system 1000 may include one or more servers 1020. Server(s) 1020 may be configured to communicate with one or more client computing platforms 1040 according to a client/server architecture and/or other architectures. Client computing platform(s) 1040 may be configured to communicate with other client computing platforms via server(s) 1020 and/or according to a peer-to-peer architecture and/or other architectures. Users may access system 1000 via client computing platform(s) 1040.

Server(s) 1020 may be configured by machine-readable instructions 1060. Machine-readable instructions 1060 may include one or more instruction modules. The instruction modules may include computer program modules. The instruction modules may include one or more of a 3D environment definition module 1080, a point of view definition module 1100, a vector computing module 1140, a multidimensional path definition module 1180, a coefficient definition module 1220, a motor controller module 1240 and/or other instruction modules.

The 3D definition module 1080 may be configured to define a three-dimensional (3D) computer generated virtual environment. The user may have a defined position in a real environment which real environment is defined using a longitudinal x axis, a lateral y axis and a perpendicular z axis.

The vector computing module 1140 may be configured to, when the user walks in the real environment, define a vector of movement r1 in the real environment and computing a first vector of movement vr1 in the 3D virtual environment from r1 with vr1 having a component x along the x axis, a component y along the y axis and a rotational component θ around the z axis. In some implementations, the θ component will vary based on the line of sight of the user as measured in the real environment. That is, rotation of the user's head will typically correspond to the θ component. The x component and the y component will vary based the actual distance travelled by the user as measured in the real environment. When the user walks on a treadmill, as skilled persons will readily acknowledge, the x component and the y component are measured from the perspective of the belt. One or more wearable devices and/or one or more sensors may be used for that purpose, as previously exemplified herein. One or more wearable devices and/or one or more sensors may be used the purpose of determining the x, y and θ components, as previously exemplified herein.

The vector computing module 1140 may be configured to, in real-time priority processing and while the user walks in the real environment, compute a second vector of movement vr2 in the 3D virtual environment having an x-translation component Δx along the x axis, a y-translation Δy component along the y axis and a rotational component Δθ around the z axis with at least one of Δx, Δy and Δθ being effective for inducing a translation and/or rotation of the point of view in the 3D virtual environment while the user walks, the induced translation and/or rotation being absent from vr1. As skilled persons will readily understand, Δθ can be defined around the z axis with a pivot point at or close to the user's head (or a point in space computed as being representative thereof).

The point of view definition module 1100 may be configured to define a point of view for a user in the 3D virtual environment. Δx may be a gain applied to a corresponding x component of vr1 with the gain Δx being different from 0. The gain Δx is typically different from 1, although a transition through 1 between different values is of course possible. The gain Δx is typically used to increase the distance perceived by the user in the virtual environment compared to the actual distance travelled in the real environment. While the gain Δx may be fixed for a given experience, it may also vary during the course of the experience. The gain Δx may be fixed to a value greater than 1 and smaller than 10.

For illustrative purposes, the relation between the vectors r1, vr1, vr2 and the induced movement of the point of view along the y axis, m_{y} (i.e., lateral translation movement) may be expressed as:
(1) m_{y}=vr1_{y}+vr2_{y} with:
(2) vr1_{y} computed from r1_{y};
(3) vr1ₓ computed from r1ₓ;
(4) vr1_{θ} computed from r1_{θ}; and
(5) vr2_{y}=Δr·(a·vr1_{y}+b·vr1ₓ+c·vr1_{θ}).

The value of a, b and c is set to induce a determined translation and, in some embodiments, also considering one or more comfort coefficients (e.g., maximum resulting vr2_{y} and/or vr2_{θ} value). As skilled people will have understood, vr2_{y} does not require vr1_{y} to be non-zero, but requires that at least one of vr1_{θ}, vr1ₓ and vr1_{y} to be non-zero to be effective. Said differently, vr2_{y} can be set to non-zero value only where the user moves. In some instances, only a gain against vr1_{y} may be performed (i.e., (Δy·a) is non-zero). Alternatively, only a gain against vr1ₓ may be performed (i.e., (Δy·b) is non-zero). Yet another alternative is to perform only a gain against θ (i.e., (Δy·c) is non-zero). Of course, as skilled persons will have understood, any combination of non-zero Δy·a, Δy·b and Δy·c values may be performed.

As can be seen, Δy (that is, Δy·a, Δy·b or Δy·c) may be set considering at least one of a distance value and a total rotation value. The distance value may be calculated from at least one of the x-component and the y-component of r1. More specifically, in some implementations, only the longitudinal distance (along x) may be considered to calculate the distance value. In other implementations, the longitudinal distance (along x) and the lateral value (along y) are considered to calculate the distance value. In some other implementations, the longitudinal distance (along x) is considered to calculate the distance value and the lateral value (along y) is only considered when a certain threshold is crossed. The total rotation value may be calculated from the θ component of r1.

For illustrative purposes, the relation between the vectors r1, vr1, vr2 and the induced rotation of the point of view around the z axis, R_{z} may be expressed as:
(1) R_{z}=vr1_{θ}+vr2_{θ} with:
(2) vr1_{y} computed from r1_{y};
(3) vr1ₓ computed from r1ₓ;
(4) vr1_{θ} computed from r1_{θ}; and
(5) vr2_{θ}=Δθ·(s·vr1_{y}+t·vr1ₓ+u·vr1_{θ}).

The value of s, t and u is set to induce a determined rotation and, in some embodiments, also considering one or more comfort coefficients (e.g., maximum resulting vr2_{y} and/or vr2_{θ} value). As skilled people will have understood, vr2_{θ} does not require vr1_{θ} to be non-zero, but requires that at least one of vr1_{θ}, vr1ₓ and vr1_{y}, to be non-zero to be effective. Said differently, vr2_{θ} can be set to non-zero value only where the user moves. In some instances, only a gain against vr1_{y} may be performed (i.e., (Δθ·s) is non-zero). Alternatively, only a gain against vr1ₓ may be performed (i.e., (Δθ·t) is non-zero). Yet another alternative is to perform only a gain against θ (i.e., (Δθ·u) is non-zero). Of course, as skilled persons will have understood, any combination of non-zero Δθ·s, Δθ·t and Δθ·u values may be performed.

A maximum value of Δθ(that is, Δθ·s, Δθ·t and Δθ·u) may be set considering the distance value, e.g., as calculated above and the total rotation value, e.g., as calculated above.

For instance, the user may walk in the real environment on a single-dimension treadmill and a speed of the treadmill may be determined to keep the user at a center position of the treadmill, along the x axis.

The point of view definition 1100 may be configured to move the point of view in the 3D virtual environment along vr1 taking into account vr2.

The user's brain will try to reconcile the information received from visual cues with feedback received from the user's inner ear vestibular systems. Typically, the user will accommodate and reconcile the two inputs, mainly based on imprecisions' or perceived imprecisions, from the inner ear vestibular systems. As such, in practice, the weight given to the inner ear vestibular systems' feedback is lower when compared to the visual cues. However, past a certain point, the user will start to feel dizzy and/or nauseous. In order to evaluate discomfort of the user in the 3D virtual environment, the coefficient definition module 1220 may be configured to define a first coefficient as Δe compared to a distance value of the user in the real environment, define a second coefficient as Δy compared to the distance value, define a third coefficient as Δe compared to a total rotation value corresponding to the user's rotation in the real environment (e.g., as measured from head rotation) and define a fourth coefficient as Δy compared to the total rotation value. In some implementations, the sum of the four coefficients will determine the maximum “correction” that may be applied between the real environment and the virtual environment. In some implementations, the highest value of the four coefficients will determine the maximum “correction” that may be applied between the real environment and the virtual environment. In some other implementations, a weighted sum of the four coefficients will determine the maximum “correction” that may be applied between the real environment and the virtual environment (e.g., the weights being determined based on the actual scale of the coefficients versus one another). In some implementations, user-specific threshold(s) may be set. For instance, height of the user may be considered to set the threshold (e.g., taller people potentially having higher sensitivity). A setup routine or test routine may also be performed for a specific user in the 3D virtual environment where different threshold values are tested and in which the use is asked to provide comfort-level feedback or in which feedback from the user is automatically obtained (e.g., from behavior of the user (such as hesitations in walking or errant walking pattern), visual cues (such as the user's hands being extended to retrieve balance), sounds from the user that may convey comfort and/or discomfort, etc.). In some implementations, user-specific settings are maintained (e.g., in a database), which may further be re-used when the same user re-enters the virtual environment. The setup routine may also be performed more than once as users tend to adapt and gradually tolerate higher levels of correction. In some implementations, the setup routine is part of the experience and the user may not be able to tell the difference between the actual experience and the routine.

The multidimensional path definition module 1180 may be configured to define a target multidimensional path in the 3D virtual environment. Computing vr2 may then be performed to match the target multidimensional path while the user walks unidimensionally in the real environment (e.g., on a treadmill). By way of non-limiting example, computing vr2 may be a computer engineering optimization problem of the first, second, third and fourth coefficients over time to match the target multidimensional path while the user walks unidimensionally in the real environment.

Moving of the point of view in the 3D virtual environment may be split into multiple frames per second wherein the vectors r1 vr1 and vr2 are computed for each of the multiple frames. The computer engineering optimization problem of the first, second, third and fourth coefficients over time may therefore be performed for more than one frame.

The motor controller module 1240 may be configured to trigger the motor assembly to drive the treadmill when a distance between a front limit of the treadmill is within a predetermined dynamic or static threshold. The motor controller module 1240 may also be configured to trigger the motor assembly to stop the treadmill when a distance between a rear limit of the treadmill is within a predetermined dynamic or static threshold. When the user walks without triggering the motor assembly to drive the treadmill, Δy may have a fixed gain value greater than 1 and Δx has a fixed gain value greater than 1. When the user walks and triggers the motor assembly to drive the treadmill, Δy has a dynamic gain value greater than 1 and Δx may then have a dynamic gain value greater than 1.

The motor controller module 1240 controls the motor assembly of the treadmill for moving the user thereon taking into account r1, vr1 and vr2.

In some implementations, server(s) 1020, client computing platform(s) 1040, and/or external resources 1300 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 1020, client computing platform(s) 1040, and/or external resources 1300 may be operatively linked via some other communication media.

A given client computing platform 1040 may include one or more processors configured to execute computer program modules. The computer program modules may be configured to enable an expert or user associated with the given client computing platform 1040 to interface with system 1000 and/or external resources 1300, and/or provide other functionality attributed herein to client computing platform(s) 1040. By way of non-limiting example, the given client computing platform 1040 may include one or more of a desktop computer, a laptop computer, a handheld computer, a tablet computing platform, a NetBook, a Smartphone, a gaming console, and/or other computing platforms.

External resources 1300 may include sources of information outside of system 1000, external entities participating with system 1000, and/or other resources. In some implementations, some or all of the functionality attributed herein to external resources 1300 may be provided by resources included in system 1000.

Server(s) 1020 may include electronic storage 1320, one or more processors 1340, and/or other components. Server(s) 1020 may include communication lines, or ports to enable the exchange of information with a network and/or other computing platforms. Illustration of server(s) 1020 in FIG. 1 is not intended to be limiting. Server(s) 1020 may include a plurality of hardware, software, and/or firmware components operating together to provide the functionality attributed herein to server(s) 1020. For example, server(s) 1020 may be implemented by a cloud of computing platforms operating together as server(s) 1020.

Electronic storage 1320 may comprise non-transitory storage media that electronically stores information. The electronic storage media of electronic storage 1320 may include one or both of system storage that is provided integrally (i.e., substantially non-removable) with server(s) 1020 and/or removable storage that is removably connectable to server(s) 1020 via, for example, a port (e.g., a USB port, a firewire port, etc.) or a drive (e.g., a disk drive, etc.). Electronic storage 1320 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1320 may include one or more virtual storage resources (e.g., cloud storage, a virtual private network, and/or other virtual storage resources). Electronic storage 1320 may store software algorithms, information determined by processor module 1340, information received from server(s) 1020, information received from client computing platform(s) 1040, and/or other information that enables server(s) 1020 to function as described herein.

The processor module 1340 may be configured to provide information processing capabilities in server(s) 1020. As such, processor module 1340 may include one or more of a digital processor, an analog processor, a digital circuit designed to process information, an analog circuit designed to process information, a state machine, and/or other mechanisms for electronically processing information. Although processor module 1340 is shown in FIG. 1 as a single entity, this is for illustrative purposes only. In some implementations, processor module 1340 may include a plurality of processing units. These processing units may be physically located within the same device, or processor module 1340 may represent processing functionality of a plurality of devices operating in coordination. Processor module 1340 may be configured to execute modules 1080, 1100, 1140, 1180, 1220, and/or 1240, and/or other modules. Processor module 1340 may be configured to execute modules 1080, 1100, 1140, 1180, 1220, and/or 1240, and/or other modules by software; hardware; firmware; some combination of software, hardware, and/or firmware; and/or other mechanisms for configuring processing capabilities on processor module 1340. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 1080, 1100, 1140, 1180, 1220, and/or 1240 are illustrated in FIG. 1 as being implemented within a single processing unit, in implementations in which processor module 1340 includes multiple processing units, one or more of modules 1080, 1100, 1140, 1180, 1220, and/or 1240 may be implemented remotely from the other modules. The description of the functionality provided by the different modules 1080, 1100, 1140, 1180, 1220, and/or 1240 described herein is for illustrative purposes, and is not intended to be limiting, as any of modules 1080, 1100, 1140, 1180, 1220, and/or 1240 may provide more or less functionality than is described. For example, one or more of modules 1080, 1100, 1140, 1180, 1220, and/or 1240 may be eliminated, and some or all of its functionality may be provided by other ones of modules 1080, 1100, 1140, 1180, 1220, and/or 1240. As another example, processor module 1340 may be configured to execute one or more additional modules that may perform some or all of the functionality attributed below to one of modules 1080, 1100, 1140, 1180, 1220, and/or 1240.

FIG. 2 illustrates a method 2000 for navigating in a virtual environment considering imprecision from user's inner ear vestibular systems, in accordance with one or more implementations. The operations of method 2000 presented below are intended to be illustrative. In some implementations, method 2000 may be accomplished with one or more additional operations not described, and/or without one or more of the operations discussed. Additionally, the order in which the operations of method 2000 are illustrated in FIG. 2 and described below is not intended to be limiting. In some implementations, method 2000 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 2000 in response to instructions stored electronically on an electronic storage medium. The one or more processing devices may include one or more devices configured through hardware, firmware, and/or software to be specifically designed for execution of one or more of the operations of method 2000.

An operation 2020 may include defining a three-dimensional, 3D, computer generated virtual environment. Operation 2020 may be performed by one or more hardware processors configured by machine-readable instructions including a module that is the same as or similar to 3D definition module 1080, in accordance with one or more implementations.

An operation 2040 may include defining a point of view for a user in the 3D virtual environment. The user may have a defined position in a real environment defined using a longitudinal x axis, a lateral y axis and a perpendicular z axis. Operation 2040 may be performed by one or more hardware processors configured by machine-readable instructions including a module that is the same as or similar to point definition module 1100, in accordance with one or more implementations.

An operation 2060 may include when the user walks in the real environment, defining a vector of movement r1 in the real environment and computing a first vector of movement vr1 in the 3D virtual environment from r1 with vr1 having a component x along the x axis, a component y along the y axis and a rotational component θ around the z axis. Operation 2060 may be performed by one or more hardware processors configured by machine-readable instructions including a module that is the same as or similar to vector definition module 1120, in accordance with one or more implementations.

An operation 2080 may include in real-time priority processing and while the user walks in the real environment, computing a second vector of movement vr2 in the 3D virtual environment having an x-translation component Δx along the x axis, a y-translation Δy component along the y axis and a rotational component Δθ around the z axis with at least one of Δx, Δy and Δθ being effective for inducing a translation and/or rotation of the point of view in the 3D virtual environment while the user walks, the induced translation and/or rotation being absent from vr1. Operation 2080 may be performed by one or more hardware processors configured by machine-readable instructions including a module that is the same as or similar to vector computing module 1140, in accordance with one or more implementations.

An operation 2100 may include moving the point of view in the 3D virtual environment along vr1 taking into account vr2. Operation 2100 may be performed by one or more hardware processors configured by machine-readable instructions including a module that is the same as or similar to point moving module 1160, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for navigating in a virtual environment considering imprecision from user's inner ear vestibular systems, the system comprising:
a single-dimension treadmill, for moving the user thereon in a real environment, having a motor assembly;
one or more hardware processors configured by machine-readable instructions to:
define a three-dimensional, 3D, computer generated virtual environment;
define a point of view for a user in the 3D virtual environment, the user having a defined position in a real environment defined using a longitudinal x axis, a lateral y axis and a perpendicular z axis;
when the user walks in the real environment, define a vector of movement r1 in the real environment and computing a first vector of movement vr1 in the 3D virtual environment from r1 with vr1 having a component x along the x axis, a component y along the y axis and a rotational component θ around the z axis;
in real-time priority processing and while the user walks in the real environment, compute a second vector of movement vr2 in the 3D virtual environment having an x-translation component Δx along the x axis, a y-translation Δy component along the y axis and a rotational component Δθ around the z axis with at least one of Δx, Δy and Δθ being effective for inducing a translation and/or rotation of the point of view in the 3D virtual environment while the user walks, the induced translation and/or rotation being absent from vr1; and
move the point of view in the 3D virtual environment along vr1 taking into account vr2.
wherein one or more hardware processors configured by machine-readable instructions to control the motor assembly of the treadmill for moving the user thereon from r1, vr1 and vr2; and
a display system that outputs images of the 3D virtual environment taking into account the point of view of the user in the 3D virtual environment.

2. The system of claim 1, wherein the one or more hardware processors are further configured by machine-readable instructions to define a target multidimensional path in the 3D virtual environment, wherein computing vr2 is performed to match the target multidimensional path while the user walks unidimensionally in the real environment.

3. The system of claim 2, wherein the one or more hardware processors are further configured by machine-readable instructions to segment the moving of the point of view in the 3D virtual environment into multiple frames per second, wherein the vectors r1, vr1 and vr2 are computed for each of the multiple frames.

4. The system of claim 2, wherein:
Δx is a gain applied to a corresponding x component of vr1 with the gain Δx being different from 0;
Δy is a dynamic gain applied to the corresponding y component of vr1 with the gain Δy being greater than 1 when inducing the translation of the point of view in the 3D virtual environment while the user walks; and
Δθ is greater or equal to 0 and added to the θ component of vr1 with Δθ being greater than 0 when inducing the rotation of the point of view in the 3D virtual environment while the user walks.

5. The system of claim 4, wherein the gain Δx is fixed to a value greater than 1 and smaller than 10.

6. The system of claim 2, wherein:
Δy is dynamically set to a value greater than 1 and smaller than 10 considering at least one of i) a distance value calculated from at least one of the x-component and the y-component of r1 and ii) a total rotation value calculated from the θ component of r1; and
a maximum value of Δθ is set considering the distance value calculated from at least one of the x-component and the y-component of r1 and the total rotation value calculated from the θ component of r1.

7. The system of claim 6, wherein the one or more hardware processors are further configured by machine-readable instructions to, in order to evaluate discomfort of the user in the 3D virtual environment, define:
a first coefficient by comparing Δθ with the distance value;
a second coefficient by comparing Δy with the distance value;
a third coefficient by comparing Δθ with the total rotation value; and
a fourth coefficient by comparing Δy with the total rotation value;
wherein computing vr2 is a computer engineering optimization problem of the first, second, third and fourth coefficients over time to match the target multidimensional path while the user walks unidimensionally in the real environment.

8. The system of claim 2, wherein the one or more hardware processors are further configured by machine-readable instructions to trigger the motor assembly to drive the treadmill when a distance between a front limit of the treadmill is within a predetermined dynamic or static threshold.

9. The system of claim 2, wherein the one or more hardware processors are further configured by machine-readable instructions to trigger the motor assembly to stop the treadmill when a distance between a rear limit of the treadmill is within a predetermined dynamic or static threshold.

10. The system of claim 2, wherein
when the user walks without triggering the motor assembly to drive the treadmill, Δy has a fixed gain value greater than 1 and Δx has a fixed gain value greater than 1; and
when the user walks and triggers the motor assembly to drive the treadmill, Δy has a dynamic gain value greater than 1 and Δx has a dynamic gain value greater than 1.

11. The system of claim 2, wherein the one or more hardware processors are further configured by machine-readable instructions to determine a speed of the treadmill for the motor assembly to keep the user at a center position of the treadmill.

12. A method for navigating in a virtual environment considering imprecision from user's inner ear vestibular systems comprising:
defining a three-dimensional, 3D, computer generated virtual environment;
defining a point of view for a user in the 3D virtual environment, the user having a defined position in a real environment defined using a longitudinal x axis, a lateral y axis and a perpendicular z axis;
when the user walks in the real environment, defining a vector of movement r1 in the real environment and computing a first vector of movement vr1 in the 3D virtual environment from r1 with vr1 having a component x along the x axis, a component y along the y axis and a rotational component θ around the z axis;
in real-time priority processing and while the user walks in the real environment, computing a second vector of movement vr2 in the 3D virtual environment having an x-translation component Δx along the x axis, a y-translation Δy component along the y axis and a rotational component Δθ around the z axis with at least one of Δx, Δy and Δθ being effective for inducing a translation and/or rotation of the point of view in the 3D virtual environment while the user walks, the induced translation and/or rotation being absent from vr1; and
moving the point of view in the 3D virtual environment along vr1 taking into account vr2.

13. The method of claim 12, further comprising defining a target multidimensional path in the 3D virtual environment, computing vr2 being performed to match the target multidimensional path while the user walks unidimensionally in the real environment.

14. The method of claim 13, further comprising segmenting the moving of the point of view in the 3D virtual environment into multiple frames per second wherein the vectors r1, vr1 and vr2 are computed for each of the multiple frames.

15. The method of claim 13, wherein:
Δx is a gain applied to a corresponding x component of vr1 with the gain Δx being different from 0 and different from 1;
Δy is a dynamic gain applied to the corresponding y component of vr1 the gain with Δy being greater than 1 when inducing the translation of the point of view in the 3D virtual environment while the user walks; and
Δθ is greater or equal to 0 and added to the θ component of vr1 with Δθ being greater than 0 when inducing the rotation of the point of view in the 3D virtual environment while the user walks.

16. The method of claim 13, wherein the gain Δx is fixed to a value greater than 1 and smaller than 10.

17. The method of claim 13, wherein:
Δy is dynamically set to a value greater than 1 and smaller than 10 considering at least one of i) a distance value calculated from at least one of the x-component and the y-component of r1 and ii) a total rotation value calculated from the θ component of r1; and
a maximum value of Δθ is set considering the distance value calculated from at least one of the x-component and the y-component of r1 and a total rotation value calculated from the θ component of r1.

18. The method of claim 13, further comprising:
to evaluate discomfort of the user in the 3D virtual environment, defining
a first coefficient defined as Δθ compared to the distance value;
a second coefficient defined as Δy compared to the distance value
a third coefficient defined as Δθ compared to the total rotation value; and
a fourth coefficient defined as Δy compared to the total rotation value;
wherein computing vr2 is a computer engineering optimization problem of the first, second, third and fourth coefficients over time to match the target multidimensional path while the user walks unidimensionally in the real environment.

19. The method of claim 13, wherein the user walks in the real environment on a single-dimension treadmill, the method further comprising controlling a motor assembly of the treadmill for moving the user thereon from r1, vr1 and vr2.

20. The method of claim 19, further comprising triggering the motor assembly to drive the treadmill when a distance between a front limit of the treadmill is within a predetermined dynamic or static threshold.

21. The method of claim 19, further comprising triggering the motor assembly to stop the treadmill when a distance between a rear limit of the treadmill is within a predetermined dynamic or static threshold.

22. The method of claim 19, wherein:
when the user walks without triggering the motor assembly to drive the treadmill, Δy has a fixed gain value greater than 1 and Δx has a fixed gain value greater than 1; and
when the user walks and triggers the motor assembly to drive the treadmill, Δy has a dynamic gain value greater than 1 and Δx has a dynamic gain value greater than 1.

23. The method of claim 19, wherein a speed of the treadmill is determined for the motor assembly to keep the user at a center position of the treadmill.

24. A non-transient computer-readable storage medium having instructions embodied thereon, the instructions being executable by one or more processors to perform a method for navigating in a virtual environment considering imprecision from user's inner ear vestibular systems, the method comprising:
defining a three-dimensional, 3D, computer generated virtual environment;
defining a point of view for a user in the 3D virtual environment, the user having a defined position in a real environment defined using a longitudinal x axis, a lateral y axis and a perpendicular z axis;
when the user walks in the real environment, defining a vector of movement r1 in the real environment and computing a first vector of movement vr1 in the 3D virtual environment from r1 with vr1 having a component x along the x axis, a component y along the y axis and a rotational component θ around the z axis;
in real-time priority processing and while the user walks in the real environment, computing a second vector of movement vr2 in the 3D virtual environment having an x-translation component Δx along the x axis, a y-translation Δy component along the y axis and a rotational component Δθ around the z axis with at least one of Δx, Δy and Δθ being effective for inducing a translation and/or rotation of the point of view in the 3D virtual environment while the user walks, the induced translation and/or rotation being absent from vr1; and
moving the point of view in the 3D virtual environment along vr1 taking into account vr2.

25. The computer-readable storage medium of claim 24, wherein the method further comprises defining a target multidimensional path in the 3D virtual environment, computing vr2 being performed to match the target multidimensional path while the user walks unidimensionally in the real environment.

26. The computer-readable storage medium of claim 25, wherein the method further comprises segmenting the moving of the point of view in the 3D virtual environment into multiple frames per second wherein the vectors r1, vr1 and vr2 are computed for each of the multiple frames.

27. The computer-readable storage medium of claim 25, wherein Δx is a gain applied to a corresponding x component of vr1 the gain Δx being different from 0 and different from 1; Δy is a dynamic gain applied to the corresponding x component of vr1 the gain Δy being greater than 1 when inducing the translation of the point of view in the 3D virtual environment while the user walks; and Δθ is greater or equal to 0 and added to the θ component of vr1 Δθ being greater than 0 when inducing the rotation of the point of view in the 3D virtual environment while the user walks.

28. The computer-readable storage medium of claim 27, wherein the gain Δx is fixed to a value greater than 1 and smaller than 10.

29. The computer-readable storage medium of claim 25, wherein Δy is dynamically set to a value greater than 1 and smaller than 10 considering at least one of i) a distance value calculated from at least one of the x-component and the y-component of r1 and ii) a total rotation value calculated from the θ component of r1; and a maximum value of Δθ is set considering i) the distance value calculated from at least one of the x-component and the y-component of r1 and ii) a total rotation value calculated from the θ component of r1.
